(19) United States
(12) Patent Application Publication
(10) Pub. No.: US 2017/0230108 A1
(43) Pub. Date: Aug. 10, 2017

(54) OPTICAL FIBER DETECTION METHOD, DETECTION DEVICE, DETECTION PLATFORM AND ELEMENT MANAGEMENT SYSTEM

(71) Applicant: ZTE CORPORATION, Shenzhen City (CN)

(72) Inventor: Yong WEN, Shenzhen City (CN)

(73) Assignee: ZTE CORPORATION, Shenzhen City (CN)

(21) Appl. No.: 15/322,270

(22) PCT Filed: Oct. 14, 2014
(86) PCT No.: PCT/CN2014/088578

§ 371 Date: Apr. 20, 2017

(30) Foreign Application Priority Data
Jun. 27, 2014 (CN) 201410305518.6

(51) Int. Cl. H04B 10/03; H04B 10/25; H04Q 11/00; H04J 14/02; H04B 10/071

(52) U.S. Cl. CPC H04B 10/03; H04J 14/02; H04B 10/071; H04Q 11/0005; H04B 10/2504; H04Q 2011/0043; H04Q 2011/0016

(57) ABSTRACT

An optical fiber detection method includes: selecting an optical fiber path required to be detected and setting relevant parameters of an optical fiber detection device related to the optical fiber path (S10); sending a detection starting instruction to the optical fiber detection device for the optical fiber detection device to detect the optical fiber path according to the detection starting instruction (S20); receiving a result of the detection performed by the optical fiber detection device on the optical fiber path, and analyzing the result of the detection to acquire the working status of the optical fiber path (S30). A network element management system and an optical fiber detection device and platform are also described.

### CROSS-REFERENCE TO RELATED APPLICATION

This application is the U.S. national phase of PCT Application No. PCT/CN2014/088578 filed Oct. 14, 2014, which claims priority to Chinese Application No. 201410305518.6 filed Jun. 27, 2014, the disclosures of which are incorporated in their entirety by reference herein.

### TECHNICAL FIELD

The present disclosure relates to the field of optical fiber communications, and in particular to an optical fiber detection method, device and platform and a network element management system.

### BACKGROUND

In optical transmission systems, the performance of transmission optical fibers and optical cables directly affects the reliability of a communication system; however, transmission optical fibers are highly likely to go wrong, for example, optical cables curve or break, in such cases, it is needed to locate the fault quickly and repair optical fibers/optical cables quickly so as to recover normal communication.

With the development of optical transmission, a great quantity of long-haul optical fibers are laid and placed, consequentially, network operation and maintenance, especially the detection and the fault location of optical fiber links, have became one of the most concerned problems for operators.

In optical transmission systems, existing optical fiber detection methods mainly use an Optical Time Domain Reflectometer (OTDR) meter or an optical fiber monitoring device with an integrated OTDR function to locate a fault after an optical fiber is faulted. However, such devices are irrelative with optical transmission devices and must be operated and used separately, therefore, for an optical fiber link equipped with no OTDR meter or device, the maintainer has to carry a meter or device to a station to locate a fault by scanning optical fibers manually, moreover, a certain degree of effect is caused to services every time an OTDR meter is connected, thus leading to high maintenance cost but low maintenance cost for the operator.

### SUMMARY

An optical fiber detection method, device and platform and a network element management system are provided in the embodiment of present disclosure to at least address the technical problem existing in the related art that optical fiber detection is time-consuming and labor-consuming and affects the transmission of service light.

To achieve the foregoing purpose, an optical fiber detection method is provided in the present disclosure, including the following steps that:
an optical fiber path required to be detected is selected, and relevant parameters of an optical fiber detection device related to the optical fiber path are set;
a detection starting instruction is sent to the optical fiber detection device for the optical fiber detection device to detect the optical fiber path according to the detection starting instruction; and
a result of the detection performed by the optical fiber detection device on the optical fiber path is received, and the result of the detection is analyzed to acquire the working status of the optical fiber path.

Alternatively, the step that an optical fiber path required to be detected is selected and relevant parameters of an optical fiber detection device related to the optical fiber path are set includes that:
the optical fiber path required to be detected is selected through a visual interface; and
the relevant parameters of the optical fiber detection device related to the selected optical fiber path are set, the relevant parameters include: the wavelength, the pulse width, the measurement distance and the acquisition time of the detection light of an OTDR and optical fiber parameters.

Alternatively, after the step that a detection starting instruction is sent to the optical fiber detection device for the optical fiber detection device to detect the optical fiber path according to the detection starting instruction, the optical fiber detection method further includes that:
an OTDR device is controlled to output detection light and transmit the detection light into the selected optical fiber path through a 1*N optical switch;
a Fiber Multiplexer-Demultiplexer (FMD) device is controlled to transmit the detection light and the service light in one path or in separate paths; and
the OTDR device is controlled to collect returned reflected light and analyze the collected reflected light.

Alternatively, the step that a FMD device is controlled to transmit the detection light and the service light in one path or in separate paths includes that:
when the detection light is selected by the 1*N optical switch, the FMD device is controlled to combine the detection light and the service light into one optical fiber for transmission; and
when the optical signal of the combined path reaches a WMD station terminal, the FMD device is controlled to filter out the detection light and continue to transmit the service light to the next station.

Alternatively, the step that the OTDR device is controlled to collect returned reflected light and analyze the collected reflected light includes that:
the OTDR device is controlled to collect returned reflected light and analyze the collected reflected light to acquire the intensity and the reception time of the detection light and those of the reflected light; and
the length l and the optical fiber loss coefficient α of the detected optical fiber are calculated according to formulas: l=(½)*(c/n)*t and Ps=P0*e^{-2α1}, in which c represents the speed of light, n represents the refractive index of a medium, and t represents the time elapsing from the moment the detection light is started to be emitted to the moment the reflected light is received.

Furthermore, a network element management system is also provided by the present disclosure, including:
a selecting and setting module arranged to select an optical fiber path required to be detected and set relevant parameters of an optical fiber detection device related to the optical fiber path;
a detection starting module arranged to send a detection starting instruction to the optical fiber detection device for the optical fiber detection device to detect the optical fiber path according to the detection starting instruction; and
a receiving and analyzing module arranged to receive a result of the detection performed by the optical fiber detection device on the optical fiber path and analyze the result of the detection to acquire the working status of the optical fiber path.

Alternatively, the selecting and setting module is arranged to:
select the optical fiber path required to be detected through a visual interface; and
set relevant parameters of the optical fiber detection device related to the selected optical fiber path, the relevant parameters of the optical fiber detection device include: the wavelength, the pulse width, the measurement distance and the acquisition time of the detection light of an OTDR and optical fiber parameters.

Alternatively, the network element management system further includes:
an OTDR module arranged to control an OTDR device to output detection light and transmit the detection light into the selected optical fiber path through a 1*N optical switch, and control the OTDR device to collect returned reflected light and analyze the collected reflected light; and
an FMD module arranged to control an FMD device to transmit the detection light and the service light in one path or in separate paths.

Alternatively, the FMD module is arranged to:
control the FMD device to combine the detection light and the service light into one optical fiber output if the detection light is selected by the 1*N optical switch; and
control the FMD device to filter out the detection light and continue to transmit the service light to the next station when the optical signal of the combined path reaches a WMD station terminal.

Alternatively, the OTDR module is arranged to:
control the OTDR device to collect returned reflected light and analyze the collected reflected light to acquire the intensity and the reception time of the detection light and those of the reflected light; and
calculate the length l and the optical fiber loss coefficient α of the detected optical fiber according to formulas: l=(½)*(c/n)*t and Ps=P0*e^{-2α1}, in which c represents the speed of light, n represents the refractive index of a medium, and t represents the time elapsing from the moment the detection light is started to be emitted to the moment the reflected light is received.

Furthermore, an optical fiber detection device is also provided which includes an OTDR device with an integrated OTDR function and an FMD device with an integrated FMD function, the OTDR device is connected with an optical fiber link.

The OTDR device includes an OTDR, a first control unit and a 1*N optical switch, herein the OTDR and the 1*N optical switch are electrically connected with the first control unit; the OTDR and the 1*N optical switch are connected through optical fibers; the first control unit controls the OTDR to emit detection light to the 1*N optical switch, controls the 1*N optical switch to select a detected optical fiber, and realizes the interaction between the OTDR device and a network element management system.

The FMD device includes a FMD and a second control unit; after detection light is selected by the 1*N switch, the detection light enter the FMD together with service light to form one optical fiber output, then the detection light included in the light signal of the combined path is filtered out by the FMD so that the service light is transmitted to the next station, and the second control unit realizes the interaction between the FMD device and the network element management system.

Furthermore, an optical fiber detection platform is also provided which includes a network element management system and an optical fiber detection device connected in communication with the network element management system, herein:

The network element management system is arranged to select an optical fiber path required to be detected, set relevant parameters of an optical fiber detection device related to the optical fiber path, send a detection starting instruction to the optical fiber detection device for the optical fiber detection device to detect the optical fiber path according to the detection starting instruction, receive a result of the detection performed by the optical fiber detection device on the optical fiber path, and analyze the result of the detection to acquire the working status of the optical fiber path.

The optical fiber detection device is arranged to receive the detection starting instruction sent from the network element management system, detect the optical fiber path required to be detected and send the result of the detection on the optical fiber path to the network element management system.

In the present disclosure, by relating an optical fiber detection device with a network element management system, selecting an optical fiber path required to be detected and setting relevant parameters of an optical fiber detection device related to the optical fiber path first, then sending a detection starting instruction to the optical fiber detection device for the optical fiber detection device to detect the optical fiber path according to the detection starting instruction, and last receiving the result of the detection performed by the optical fiber detection device on the optical fiber path and analyzing the result of the detection to acquire the working status of the optical fiber path, the present disclosure frees the maintainer from carrying a meter or device to a station to locate a fault by scanning optical fibers manually, avoids the effect that is caused to services every time an OTDR meter is connected, reduces the maintenance cost of the operator, and improves optical fiber detection efficiency.

### BRIEF DESCRIPTION OF DRAWINGS

FIG. 1 is a flowchart illustrating a first embodiment of the optical fiber detection method of the present disclosure;

FIG. 2 is a flowchart illustrating the detailed flow of the step of selecting an optical fiber path required to be detected and setting relevant parameters of an optical fiber detection device related to the optical fiber path shown in FIG. 1;

FIG. 3 is a flowchart illustrating a second embodiment of the optical fiber detection method of the present disclosure;

FIG. 4 is a flowchart illustrating the detailed flow of the step of controlling an FMD device to transmit the detection light and the service light in one path or in separate paths shown in FIG. 3;

FIG. 5 is flowchart illustrating the detailed flow of the step of controlling an OTDR device to collect returned reflected light and analyzing the collected reflected light shown in FIG. 3;

FIG. 6 is a schematic diagram illustrating functional modules of a first embodiment of the network element management system of the present disclosure;

FIG. 7 is a schematic diagram illustrating functional modules of a second embodiment of the network element management system of the present disclosure;

FIG. 8 is a schematic diagram illustrating the structure of the optical fiber detection device of the present disclosure;

FIG. 9 is a schematic diagram illustrating the structure of an OTDR device of the present disclosure;

FIG. 10 is a schematic diagram illustrating the structure of an FMD device of the present disclosure;

FIG. 11 is a schematic diagram illustrating the structure of the optical fiber detection platform of the present disclosure; and

FIG. 12 is a structural schematic diagram illustrating the application of the optical fiber detection device of the present disclosure to an optical transmission system.

The objects, the functional features and the advantages of the present disclosure will be described below with reference to accompanying drawings in conjunction with embodiments.

### SPECIFIC EMBODIMENTS OF THE PRESENT DISCLOSURE

It should be appreciated that the specific embodiment described herein are merely illustrative of, but are not intended to limit the present disclosure.

An optical fiber detection method is provided in the present disclosure.

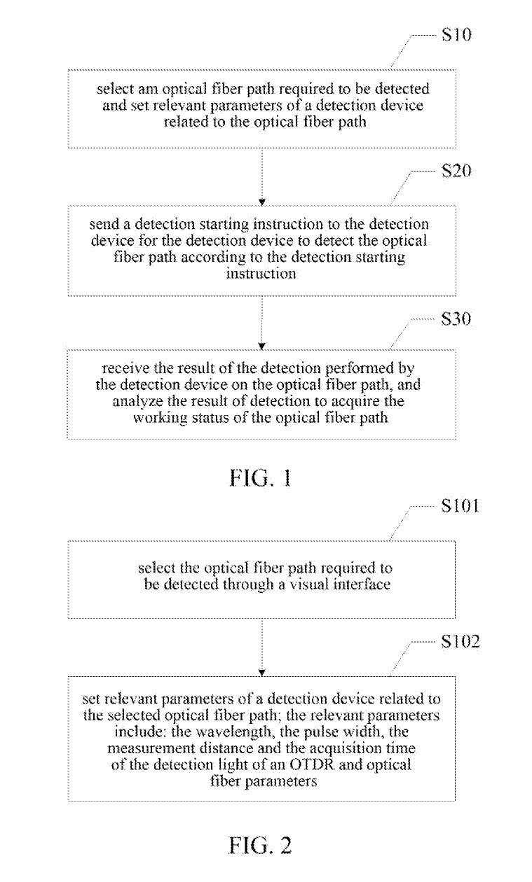

Refer to FIG. 1, FIG. 1 is a flowchart illustrating a first embodiment of the optical fiber detection method of the present disclosure.

In an embodiment, the optical fiber detection method includes:

Step 10: an optical fiber path required to be detected is selected, and relevant parameters of an optical fiber detection device related to the optical fiber path are set;

The optical fiber path required to be detected is selected by a network element management system, and relevant parameters of an OTDR device are set by the network element management system;

Step 20: a detection starting instruction is sent to the optical fiber detection device for the optical fiber detection device to detect the optical fiber path according to the detection starting instruction;

The network element management system sends the detection starting instruction to the optical fiber detection device, and the optical fiber detection device emits detection light towards the selected optical fiber path after receiving the instruction.

Step 30: the result of the detection performed by the optical fiber detection device on the optical fiber path is received, and the result of the detection is analyzed to acquire the working status of the optical fiber path.

The OTDR module of the network element management system controls the optical fiber detection device to collect returned reflected light and scattered light, the optical fiber detection device analyzes the data collected to obtain a result of the detection, then the optical fiber detection device feeds back the result of the detection to the network management system so that the optical attenuation and other information of the detected optical fiber can be queried on the network element management system; and after the current optical fiber is detected, the next optical fiber path can be manually switched to be detected, or an automatic polling detection is set.

In the embodiment, because an optical fiber detection device is added at a station and related with a network element management system, a multi-path detection for transmission optical fibers is realized by selecting an optical fiber path required to be detected and setting relevant parameters of an optical fiber detection device related to the optical fiber path first, then sending a detection starting instruction to the optical fiber detection device for the optical fiber detection device to detect the optical fiber path according to the detection starting instruction, and last receiving the result of the detection performed by the optical fiber detection device on the optical fiber path and analyzing the result of the detection to acquire the working status of the optical fiber path, thus freeing the maintainer from carrying a meter or device to a station to locate a fault by scanning optical fibers manually, avoiding the effect that is caused to services every time an OTDR meter is connected, reducing the maintenance cost of the operator, and improving optical fiber detection efficiency.

Further, refer to FIG. 2, FIG. 2 is a flowchart illustrating the detailed flow of the step of selecting an optical fiber path required to be detected and setting relevant parameters of an optical fiber detection device related to the optical fiber path shown in FIG. 1.

Step S10 includes:

Step S101: the optical fiber path required to be detected is selected through a visual interface.

The network element management system displays each optical fiber path on a visual interface for the user to select an optical fiber path required to be detected, thus avoiding the identification of optical fiber paths with pure data information and improving the ease of use for the user.

Step S102: relevant parameters of an optical fiber detection device related to the optical fiber path are set, and the relevant parameters include: the wavelength, the pulse width, the measurement distance and the acquisition time of the detection light of an OTDR and optical fiber parameters.

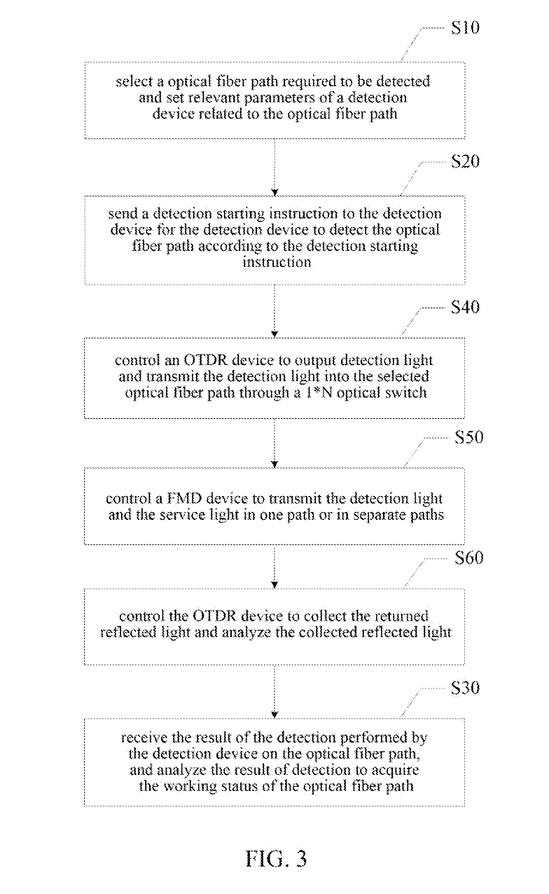

Further, refer to FIG. 3, FIG. 3 is a flowchart illustrating a second embodiment of the optical fiber detection method of the present disclosure.

In the second embodiment, the optical fiber detection method further includes the following steps after Step 20:

Step S40: an OTDR device is controlled to output detection light and transmit the detection light into the selected optical fiber path through a 1*N optical switch;

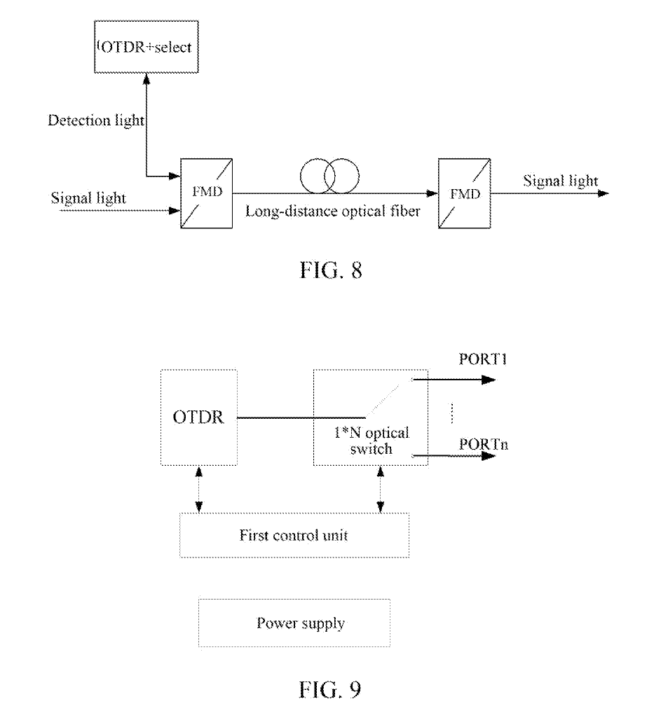

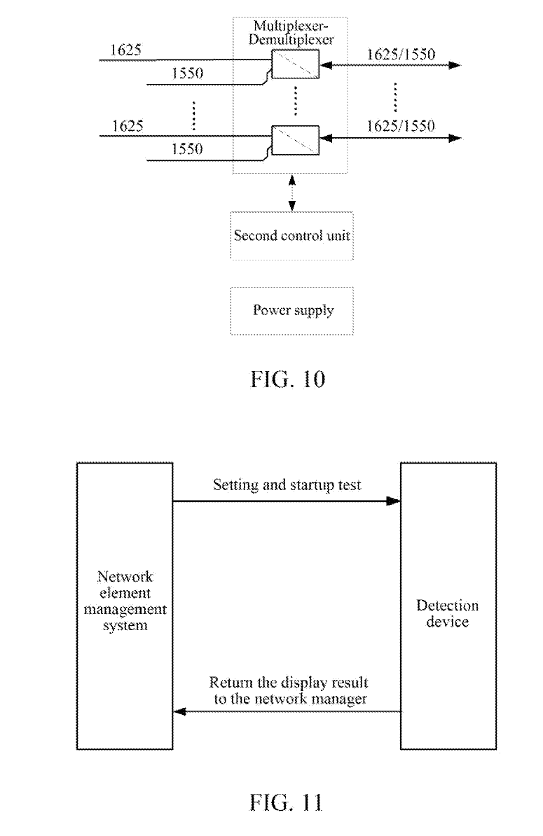

Refer to FIG. 8, FIG. 9 and FIG. 10, when the OTDR device is controlled to emit detection light, the optical fiber to be detected is selected according to the 1*N optical switch, for example, if PORT1 (port 1) is selected by the optical switch, then the optical fiber that is to be detected and matched with PORT1 is detected; if PORT2 is selected by the optical switch, then the optical fiber that is to be detected and matched with PORT2 is detected, so on and so forth, if PORTn is selected by the optical switch, then the optical fiber that is to be detected and matched with PORTn is detected.

Step S50: an FMD device is controlled to transmit the detection light and the service light in one path or in separate paths;

Refer to FIG. 8, FIG. 9 and FIG. 10, after the detection light emitted from the OTDR device is selected through the optical switch, the detection light and service light enter the FMD device together to be combined into one optical fiber output via a fiber Multiplexer-Demultiplexer (FMD); at a WDM station terminal, the optical signal of the combined path passes through the FMD so that the detection light is filtered out and the service light is mechanically transmitted to the next station. Generally, the detection light is defined as the light of L waveband (1625 nm) and the service light is defined as the light of C waveband (1550 nm) so that the FMD device can detect transmission optical fibers without affecting services.

Step S60: the OTDR device is controlled to collect returned reflected light and analyze the collected reflected light.

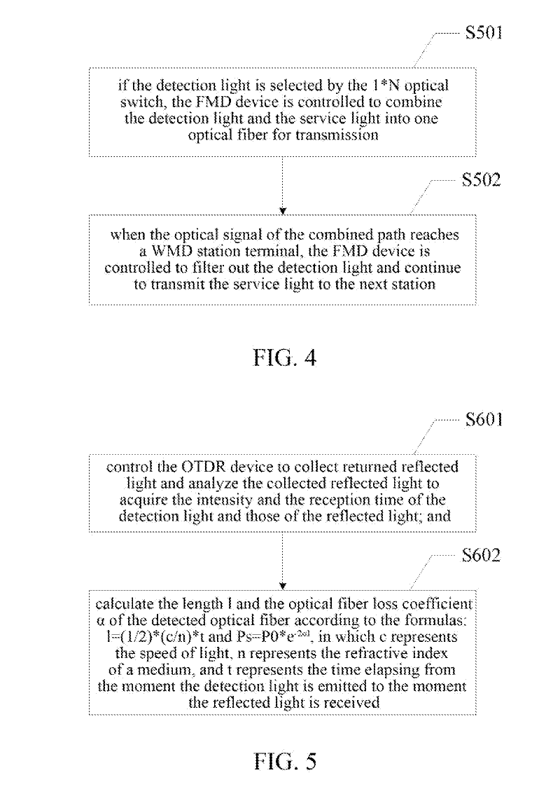

Further, refer to FIG. 4, FIG. 4 is a flowchart illustrating the detailed flow of the step of controlling an FMD device to transmit the detection light and the service light in one path or in separate paths shown in FIG. 3.

Step S50 includes:

Step S501: if the detection light is selected by the 1*N optical switch, the FMD device is controlled to combine the detection light and the service light into one optical fiber for transmission;
after the detection light emitted from the OTDR device is selected through the optical switch, the detection light and the service light enter the FMD device together to be combined into one optical fiber output by the FMD.

Step S502: when the optical signal of the combined path reaches a WMD station terminal, the FMD device is controlled to filter out the detection light and continue to transmit the service light to the next station.

At a WDM station terminal, the optical signal of the combined path passes through the FMD so that the detection light is filtered out and the service light is mechanically transmitted to the next station.

Generally, the detection light is defined as the light of L waveband (1625 nm) and the service light is defined as the light of C waveband (1550 nm) so that the FMD device can detect transmission optical fibers without affecting service; and the 1*N switch is generally a 1*4 or 1*8 optical switch.

Further, refer to FIG. 5, FIG. 5 is flowchart illustrating the detailed flow of the step of controlling an OTDR device to collect returned reflected light and analyzing the collected reflected light shown in FIG. 3.

Step S60 includes:

Step S601: the OTDR device is controlled to collect returned reflected light and analyze the collected reflected light to acquire the intensity and the reception time of the detection light and those of the reflected light; and

Step S602: the length l and the optical fiber loss coefficient α of the detected optical fiber are calculated according to the formulas: l=(½)*(c/n)*t and Ps=P0*e^{-2α1}, in which c represents the speed of light, n represents the refractive index of a medium, and t represents the time elapsing from the moment the detection light is started to be emitted to the moment the reflected light is received.

By comparing the intensity of the detection light, that of the reflected light and the length l and the optical fiber loss coefficient α of the detected optical fiber that are calculated according to the formulas: l=(½)*(c/n)*t and Ps=P0*e^{-2α1}, a track depicting the intensity of the signal in the whole optical fiber is obtained, thus facilitating the acquisition of the working status of the optical fiber path.

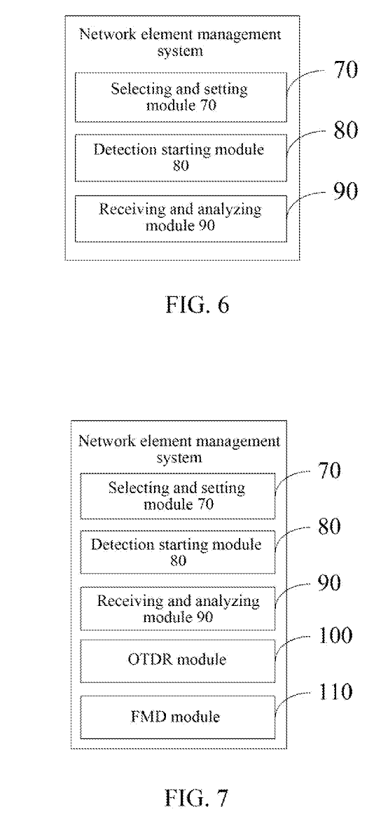

Furthermore, a network element management system is also provided by the present disclosure, refer to FIG. 6, FIG. 6 is a schematic diagram illustrating functional modules of a first embodiment of the network management system of the present disclosure.

In the first embodiment, the network element management system includes:
a selecting and setting module 70 arranged to select an optical fiber path required to be detected and set relevant parameters of an optical fiber detection device related to the optical fiber path;
the selecting and setting module 70 selects an optical fiber path required to be detected and sets relevant parameters of an OTDR device;
the selecting and setting module 70 sends a detection starting instruction to the optical fiber detection device, and the optical fiber detection device emits detection light towards the selected optical fiber path after receiving the instruction;
a detection starting module 80 arranged to send a detection starting instruction to the optical fiber detection device for the optical fiber detection device to detect the optical fiber path according to the detection starting instruction; and
a receiving and analyzing module 90 arranged to receive a result of the detection performed by the optical fiber detection device on the optical fiber path and analyze the result of the detection to acquire the working status of the optical fiber path.

The OTDR module of the network element management system controls the optical fiber detection device to collect returned reflected light and scattered light, the optical fiber detection device analyzes the data collected to obtain a result of the detection, then the optical fiber detection device feeds back the result of the detection to the network management system so that the optical attenuation and other information of the detected optical fiber can be queried on the network element management system; after the current optical fiber is detected, the next optical fiber path can be manually switched to for detection, or an automatic polling detection is set.

In the embodiment, because an optical fiber detection device is additionally arranged at a station and related with a network element management system, a multi-path detection for transmission optical fibers is realized in the following way: first, the selecting and setting module 70 selects an optical fiber path required to be detected and sets relevant parameters of an optical fiber detection device related to the optical fiber path, then the detection starting module 80 sends a detection starting instruction to the optical fiber detection device for the optical fiber detection device to detect the optical fiber path according to the detection starting instruction, and last the receiving and analyzing module 90 receives the result of the detection performed by the optical fiber detection device on the optical fiber path and analyzes the result of the detection to acquire the working status of the optical fiber path, thus freeing the maintainer from carrying a meter or device to a station to locate a fault by scanning optical fibers manually, avoiding the effect that is caused to services every time an OTDR meter is connected, reducing the maintenance cost of the operator, and improving optical fiber detection efficiency.

Further, the selecting and setting module 70 is arranged to:
select an optical fiber path required to be detected through a visual interface;
the network element management system displays each optical fiber path on a visual interface for the user to select an optical fiber path required to be detected, thus avoiding the identification of optical fiber paths with pure data information and improving the ease of use for the user; and
set relevant parameters of an optical fiber detection device related to the optical fiber path, the relevant parameters include: the wavelength, the pulse width, the measurement distance and the acquisition time of the detection light of an OTDR and optical fiber parameters of the OTDR.

Further, refer to FIG. 7, FIG. 7 is a schematic diagram illustrating functional modules of a second embodiment of the network element management system of the present disclosure.

In the second embodiment, the network element management system further includes:
an OTDR module 100 arranged to control an OTDR device to output detection light and emit the detection light into the selected optical fiber path through a 1*N optical switch and control the OTDR device to collect returned reflected light and analyze the collected reflected light.

Refer to FIG. 8, FIG. 9 and FIG. 10, when the OTDR module 100 controls the OTDR device to emit detection light, the optical fiber to be detected is selected according to the 1*N optical switch, for example, if PORT1 (port 1) is selected by the optical switch, then the optical fiber that is to be detected and matched with PORT1 is detected; if PORT2 is selected by the optical switch, then optical fiber that is to be detected and matched with PORT2 is detected, so on and so forth, if PORTn is selected by the optical switch, then optical fiber that is to be detected and matched with PORTn is detected; then, the OTDR device is controlled to collect returned reflected light and analyze the collected reflected light.

An FMD module 110 arranged to control an FMD device to transmit the detection light and service light in one path or in separate paths.

After the detection light emitted from the OTDR device is selected through the optical switch, the detection light and the service light from the FMD module 110 enter the FMD device together to be combined into one optical fiber output via a fiber Multiplexer-Demultiplexer (FMD); at a WDM station terminal, the optical signal of the combined path passes through the FMD so that the detection light is filtered out and the service light is mechanically transmitted to the next station. Generally, the detection light is defined as the light of L waveband (1625 nm) and the service light is defined as the light of C waveband (1550 nm) so that the FMD device can detect transmission optical fibers without affecting services.

Further, the OTDR module 100 is arranged to:
control the OTDR device to collect returned reflected light and analyze the collected reflected light to acquire the intensity and the reception time of the detection light and those of the reflected light; and
calculate the length l and the optical fiber loss coefficient α of the detected optical fiber according to the formulas: l=(½)*(c/n)*t and Ps=P0*e^{-2α1}, in which c represents the speed of light, n represents the refractive index of a medium, and t represents the time elapsing from the moment the detection light is started to be emitted to the moment the reflected light is received.

The OTDR module 100 compares the intensity of the detection light, that of the reflected light and the length l and the optical fiber loss coefficient α of the detected optical fiber that are calculated according to the following formulas: l=(½)*(c/n)*t and Ps=P0*e^{-2α1}, to obtain a track depicting the intensity of the signal in the whole optical fiber, thus facilitating the acquisition of the working status of the optical fiber path.

Further, an optical fiber detection device is provided which, refer to FIG. 8, FIG. 9 and FIG. 10, includes an OTDR device with an integrated OTDR function and an FMD device with an integrated FMD function, the OTDR device is connected with an optical fiber link. The OTDR device includes an OTDR, a first control unit and a 1*N optical switch, herein the OTDR and the 1*N optical switch are electrically connected with the first control unit; the OTDR and 1*N optical switch are connected with each other through optical fibers; the first control unit controls the OTDR to emit detection light towards the 1*N optical switch and controls the 1*N optical switch to select a detected optical fiber and realizes the interaction between the OTDR device and a network element management system.

The FMD device includes an FMD and a second control unit; the detection light, after being selected by the 1*N switch, enter the FMD together with service light to form one optical fiber output, then the detection light included in the light signal of the combined path is filtered out by the FMD so that the service light is transmitted to the next station, and the second control unit realizes the interaction between the FMD device and the network element management system.

Furthermore, an optical fiber detection platform is also provided by the present disclosure, and refer to FIG. 11, it includes a network element management system and an optical fiber detection device connected in communication with the network element management system. Herein:

The network element management system is arranged to select an optical fiber path required to be detected, set relevant parameters of an optical fiber detection device related to the optical fiber path, send a detection starting instruction to the optical fiber detection device for the optical fiber detection device to detect the optical fiber path according to the detection starting instruction, receive a result of the detection performed by the optical fiber detection device on the optical fiber path, and analyze the result of the detection to acquire the working status of the optical fiber path.

The optical fiber detection device is arranged to receive the detection starting instruction sent from the network element management system, detect the optical fiber path required to be detected and send the result of the detection on the optical fiber path to the network element management system.

In the embodiment, because an optical fiber detection device is added at a station and related with a network element management system, a multi-path detection for transmission optical fibers is realized by selecting an optical fiber path required to be detected and setting relevant parameters of an optical fiber detection device related to the optical fiber path first, then sending a detection starting instruction to the optical fiber detection device for the optical fiber detection device to detect the optical fiber path according to the detection starting instruction, and last receiving the result of the detection performed by the optical fiber detection device on the optical fiber path and analyzing the result of the detection to acquire the working status of the optical fiber path, thus freeing the maintainer from carrying a meter or device to a station to locate a fault by scanning optical fibers manually, avoiding the effect that is caused to services every time an OTDR meter is connected, reducing the maintenance cost of the operator, and improving optical fiber detection efficiency.

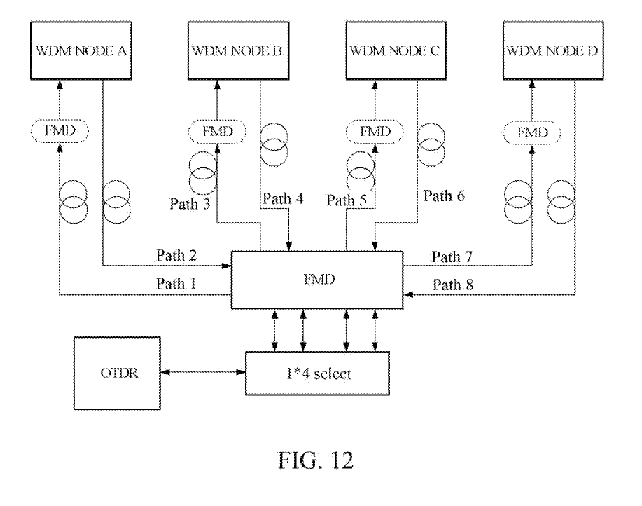

Refer to FIG. 12, FIG. 12 is a structural schematic diagram illustrating the application of the detection device of the present disclosure to an optical transmission system, there are four stations: stations A/B/C/D in the diagram, in any one of which an integrated OTDR device and an FMD device may be placed. The detection light emitted from an OTDR and an optical fiber to be detected (one of paths 2/4/6/8) are merged into one optical fiber through the FMD, paths 1/3/5/7 are selected to transmit the merged light to the four stations A/B/C/D, before entering the stations, the merged light passes through the FMD again to filter out the detection wave 1625 and transmit the service light 1550 transparently to the stations, thereby realizing the detection of four optical fiber links.

What is described above are embodiments, but they are not intended to limit the patent scope of the present disclosure, and that any equivalent structures or transformed flow devised based on the description and the accompanying drawings of the present disclosure or directly or indirectly applied to other related technical fields should fall within the patent protection scope of the present disclosure.

### INDUSTRIAL APPLICABILITY

As stated above, the optical fiber detection method, device and platform and the network element management system provided by the embodiments of the present disclosure have the following beneficial effects: there is no need to request a maintainer to carry a meter or device to a station to locate a fault by scanning optical fibers manually, the effect is avoided which is caused to services every time an OTDR meter is connected, the maintenance cost of the operator is reduced, and optical fiber detection efficiency is improved.

1. An optical fiber detection method, wherein the online optical fiber detection method comprises following steps:
selecting an optical fiber path required to be detected and setting relevant parameters of an optical fiber detection device related to the optical fiber path;
sending a detection starting instruction to the optical fiber detection device for the optical fiber detection device to detect the optical fiber path according to the detection starting instruction; and
receiving a result of the detection performed by the optical fiber detection device on the optical fiber path, and analyzing the result of the detection to acquire a working status of the optical fiber path.

2. The optical fiber detection method according to claim 1, wherein the step of selecting an optical fiber path required to be detected and setting relevant parameters of an optical fiber detection device related to the optical fiber path comprises:
selecting the optical fiber path required to be detected through a visual interface; and
setting relevant parameters of the optical fiber detection device related to the selected optical fiber path, wherein the relevant parameters include: a wavelength, a pulse width, a measurement distance and acquisition time of detection light of an Optical Time Domain Reflectometer, OTDR, and optical fiber parameters.

3. The optical fiber detection method according to claim 1, wherein after the step of sending a detection starting instruction to the optical fiber detection device for the optical fiber detection device to detect the optical fiber path according to the detection starting instruction, the optical fiber detection method further comprises:
controlling an OTDR device to output detection light and transmit the detection light into a selected optical fiber path through a 1*N optical switch;
controlling a fiber Multiplexer-Demultiplexer, FMD, device to transmit the detection light and service light in one path or in separate paths; and
controlling the OTDR device to collect returned reflected light and analyze the collected reflected light.

4. The optical fiber detection method according to claim 3, wherein the step of controlling a FMD device to transmit the detection light and service light in one path or in separate paths comprises:
when the detection light is selected by the 1*N optical switch, controlling the FMD device to combine the detection light and the service light into one optical fiber for transmission; and
when an optical signal of combined path reaches a WMD station terminal, controlling the FMD device to filter out the detection light and continue to transmit the service light to a next station.

5. The optical fiber detection method according to claim 3, wherein the step of controlling the OTDR device to collect returned reflected light and analyze the collected reflected light comprises:
controlling the OTDR device to collect returned reflected light and analyze intensity and reception time of the detection light and those of the reflected light; and
calculating a length l and optical fiber loss coefficient α of detected optical fiber according to formulas: l=(½)*(c/n)*t and Ps=P0*e^{-2α1}, in which c represents the speed of light, n represents a refractive index of a medium, and t represents time elapsing from the moment the detection light is started to be emitted to the moment the reflected light is received.

6. A network element management system, comprising:
a selecting and setting module arranged to select an optical fiber path required to be detected and set relevant parameters of an optical fiber detection device related to the optical fiber path;
a detection starting module arranged to send a detection starting instruction to the optical fiber detection device for the optical fiber detection device to detect the optical fiber path according to the detection starting instruction; and
a receiving and analyzing module arranged to receive a result of the detection performed by the optical fiber detection device on the optical fiber path and analyze the result of the detection to acquire a working status of the optical fiber path.

7. The network element management system according to claim 6, wherein the selecting and setting module is arranged to:
select the optical fiber path required to be detected through a visual interface, and
set relevant parameters of the optical fiber detection device related to the selected and detected optical fiber path, wherein the relevant parameters of the optical fiber detection device include: a wavelength, a pulse width, a measurement distance and acquisition time of detection light of an Optical Time Domain Reflectometer, OTDR, and optical fiber parameters.

8. The network element management system according to claim 6, further comprising:
an OTDR module arranged to control an OTDR device to output detection light and transmit the detection light into the selected optical fiber path through a 1*N optical switch, and control the OTDR device to collect returned reflected light and analyze the collected reflected light; and
a fiber Multiplexer-Demultiplexer, FMD, module arranged to control a FMD device to transmit the detection light and service light in one path or in separate paths.

9. The network element management system according to claim 6, wherein the FMD module is arranged to:
control a FMD device to combine detection light and service light into one optical fiber for transmission if the detection light is selected by a 1*N optical switch, and
control the FMD device to filter out the detection light and continue to transmit the service light to a next station when an optical signal of combined path reaches a WMD station terminal.

10. The network element management system according to claim 6, wherein the OTDR module is arranged to:
control an OTDR device to collect returned reflected light and analyze the collected reflected light to acquire an intensity and reception time of detection light and those of reflected light, and
calculate a length l and optical fiber loss coefficient α of detected optical fiber according to formulas: l=(½)*(c/n)*t and Ps=P0*e^{-2α1}, in which c represents the speed of light, n represents a refractive index of a medium, and t represents time elapsing from the moment the detection light is started to be emitted to the moment the reflected light is received.

11. An optical fiber detection device, comprising: an Optical Time Domain Reflectometer, OTDR, device with an integrated OTDR function and a fiber Multiplexer-Demultiplexer, FMD, device with an integrated FMD function, wherein the OTDR device is connected with an optical fiber link;
the OTDR device comprises an OTDR, a first control unit and a 1*N optical switch, wherein the OTDR and the 1*N optical switch are electrically connected with the first control unit; the OTDR and the 1*N optical switch are connected through optical fibers; the first control unit controls the OTDR to emit detection light to the 1*N optical switch, controls the 1*N optical switch to select an optical fiber to be detected and realizes an interaction between the OTDR device and a network element management system; and
the FMD device comprises a FMD and a second control unit; the detection light, after being selected by the 1*N optical switch, enter the FMD together with service light to form one optical fiber output, then the detection light included in a light signal of combined path is filtered out by the FMD so that the service light is transmitted to a next station, and the second control unit realizes an interaction between the FMD device and the network element management system.

12. An optical fiber detection platform, comprising: a network element management system according to claim 6 and an optical fiber detection device connected in communication with the network element management system, wherein
the optical fiber detection device is arranged to receive the detection starting instruction sent from the network element management system, detect the optical fiber path required to be detected and send the result of the detection on the optical fiber path to the network element management system.
